(19) United States
(12) Patent Application Publication
(10) Pub. No.: US 2024/0146576 A1
(43) Pub. Date: May 2, 2024

(54) DISTRIBUTED TUNNEL TERMINATION

(71) Applicant: Level 3 Communications, LLC, Broomfield, CO (US)

(72) Inventors: Michael FELDPUSCH, Murrells Inlet, SC (US); William HOXWORTH, Westminster, CO (US)

(73) Assignee: Level 3 Communications, LLC, Broomfield, CO (US)

(21) Appl. No.: 18/496,308

(22) Filed: Oct. 27, 2023

Related U.S. Application Data
(60) Provisional application No. 63/381,828, filed on Nov. 1, 2022.

(51) Int. Cl. H04L 12/46; H04L 9/40; H04L 45/74

(52) U.S. Cl. CPC H04L 12/4633; H04L 45/74; H04L 63/1458

(57) ABSTRACT

One or more encapsulation tunnel aggregator devices are distributed across a provider's network. The tunnel aggregator device(s) may receive clean return traffic from a managed security router (MSR) and route the traffic to a customer endpoint via an encapsulation tunnel, thereby reducing the routing burden on the MSR. The tunnel aggregator device(s) may be deployed in physical or logical proximity to an MSR, which may facilitate the routing of return traffic from the MSR to the tunnel aggregator device(s), for ultimate transmission to a customer endpoint. In other examples, a tunnel aggregator device may be deployed in proximity to other provider network resources, such as a provider edge router.

### CROSS-REFERENCE TO RELATED APPLICATIONS

This application claims the benefit of U.S. Provisional Application No. 63/381,828 filed Nov. 1, 2022, entitled “Distributed Tunnel Termination,” which is incorporated herein by reference in its entirety.

### BACKGROUND

Computing networks are increasingly targeted by malicious actors attempting to disrupt the normal functioning or operation of a targeted network. For example, denial of service (DoS) and distributed denial of service (DDoS) attacks may attempt to overwhelm the hardware or software resources of a computing network by flooding these hardware or software resources with large numbers of redundant queries. The large volume of malignant network traffic interferes with or prevents legitimate traffic from being processed by network resources. A customer of a network service provider may use a threat mitigation service offered by the service provider to help prevent the malignant traffic from burdening the customer's resources. With this approach, network traffic may be routed to threat mitigation devices on the provider's network, and the screened or filtered traffic returned to the customer's network with the malignant traffic removed. It is with respect to this general technical environment that aspects of the present technology disclosed herein are directed.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In nonexclusive aspects, the current application discloses a method (and associated system(s) for performing the method), the method comprising: causing a first encapsulation tunnel to be established between a tunnel aggregator device and a first customer routing device; receiving, at the tunnel aggregator device and from a first managed security router of a provider network, a first plurality of packets addressed to a first customer endpoint; encapsulating, by the tunnel aggregator device, the first plurality of packets; providing the encapsulated first plurality of packets to the first customer routing device using the first encapsulation tunnel; receiving, at the tunnel aggregator device and from a second managed security router of the provider network, a second plurality of packets addressed to the first customer endpoint; encapsulating, by the tunnel aggregator device, the second plurality of packets; and providing the encapsulated second plurality of packets to the first customer routing device using the first encapsulation tunnel.

### BRIEF DESCRIPTION OF THE DRAWINGS

The following drawing figures, which form a part of this application, are illustrative of aspects of systems and methods described below and are not meant to limit the scope of the disclosure in any manner, which scope shall be based on the claims.

FIG. 1 is a block diagram of an example distributed encapsulation tunnel networking environment.

FIG. 2 depicts an example method in which aspects of the present technology may be practiced by a tunnel aggregator device.

FIG. 3 depicts an example method in which aspects of the present technology may be practiced by a managed security router.

FIG. 4 is a block diagram of an example computing device.

### DETAILED DESCRIPTION

Computing networks are routinely targeted for DoS and DDoS attacks (collectively referred to herein as DDoS attacks). In a DDoS attack, a number of computing devices may send a large volume of service requests or other queries to an organization's network resources in an attempt to overwhelm the resources of the targeted network. These superfluous requests degrade the ability of network resources to service legitimate requests. In a DDoS attack, the attacking devices may spoof multiple Internet Protocol (IP) addresses at the same time to mask the attacker's location, making it difficult to mitigate the attack.

Customers of a network service provider may turn to the network service provider to assist in filtering out unwanted network traffic before it reaches the customer's network or computing resources. One approach for mitigating a DDoS attack is to route incoming network traffic through a scrubbing center, which may identify malicious packets within the traffic and remove these packets before they reach the customer's network. The targeted organization may request threat mitigation services from their network service provider (herein referred to as a provider), which may offer use of a threat mitigation system that includes a scrubbing center. In examples, the scrubbing center may include a plurality of scrubbing devices that analyze and clean the traffic, and a managed security router (MSR) that manages traffic into and out of the scrubbing devices.

The request for threat mitigation services may include packet routing instructions from the customer, such as instructions for how clean traffic should be routed back to the customer's network, preferences for data rate or bandwidth of the return path for clean data packets, and/or other instructions and service preference information. The provider may use the received packet routing instructions to configure various resources of the threat mitigation system, and/or the provider's own network, to deliver threat mitigation services to the requesting customer. For example, the MSR may be configured to route the clean return traffic to the customer network based on the customer-provided packet routing instructions and/or available network resources or capacity.

In one example, a customer may provide routing instructions indicating that clean return traffic should be routed from the scrubbing center to the customer network through an Internet circuit/network/service to which the customer is already subscribed. The MSR may be configured to identify the customer's traffic and route it to the customer network accordingly. In other examples, the customer may request that clean return traffic be routed to the customer network via one or more encapsulation tunnels. For example, Generic Routing Encapsulation (GRE) tunnels, Internet Protocol secure (IPsec) tunnels, or other forms of encapsulation tunneling may be used. Data packet encapsulation involves wrapping a first data packet that uses one protocol inside an outer data packet (encapsulating packet) that uses a different protocol, with a packet header attached to the outer encapsulating packet. The header information of the outer encapsulating packet may specify the endpoints of the tunnel as the source and destination IP addresses. The encapsulated data packet is sent from the source network endpoint (such as a provider router) to a specific target destination endpoint (such as a customer premise router), and any intervening network resources (such as other routers which are not the target destination endpoint) do not access the encapsulated packet, only the header of the outer packet. When the encapsulated data is received at the destination endpoint, the outer data packet and header are stripped away, and the original (first) data packet can then be accessed. Thus, a “tunnel” is formed where only the two endpoints have access to the original data packet.

There may be several benefits to using encapsulation tunnels, such as GRE, that may lead a customer to prefer this approach. The use of encapsulation tunnels may allow a customer to spread traffic over multiple return paths, easing the burden on any one set of network resources (such as network resources located in a specific city or geography). Encapsulation tunnels may also facilitate the use of a provider's services (such as threat mitigation services) even though the customer may use a different Internet service provider (ISP). An encapsulation tunnel may simplify and secure network connections between the service provider and end-customer, through a third-party ISP's network. Finally, an encapsulation tunnel may allow for rapid provisioning of threat mitigation or other services to a customer experiencing a DDoS attack, as an encapsulation tunnel may provide a return path that is simpler/faster to establish than other approaches. In examples, there may be other reasons for a customer to prefer using encapsulation tunnels from the provider to the customer's network.

In examples, a customer may prefer to receive clean return traffic from an MSR using an encapsulation tunnel that is established between the MSR (as a source tunnel endpoint) and a customer destination endpoint. However, the number of tunnels that can be supported by an MSR may be limited by the resources or capacity of the MSR. For example, the number of physical ports available on the MSR or other performance constraints may limit the number of encapsulation tunnels that can be established by the MSR. In addition, bandwidth normally reserved to process DDoS attacks is taken up by bandwidth reserved for the encapsulation tunnel. As customer demand for threat mitigation services increases, an MSR may be unable to support both its primary function of routing traffic into and out of the scrubbing devices of a scrubbing center, while also meeting customer demand for clean traffic to be returned via an encapsulation tunnel. In examples where an MSR is operating at capacity, but customer packet routing instructions specify the use of encapsulation tunnels, the MSR may route the return traffic to another provider network resource that has the capacity to support an encapsulation tunnel return path. For instance, a first MSR operating at capacity may route return traffic to a second provider MSR in another locale, where an encapsulation tunnel may then be established with the customer endpoint. This process (which may be referred to as “backhauling”), may add significant delays, or latency, to the customer traffic, which may negatively impact the customer.

As described herein, in examples, the present technology alleviates MSR encapsulation tunnel capacity limitations by using tunnel aggregator devices distributed across a provider's network. A tunnel aggregator device may be a server or similar computing resource capable of establishing encapsulation tunnels with a number of customer endpoints. As such, a tunnel aggregator device may receive clean return traffic from an MSR and route the traffic to a customer endpoint via an encapsulation tunnel, thereby reducing the routing burden on the MSR. Relative to an MSR, a tunnel aggregator device may offer significant benefits to a network service provider, such as being easier to operate, easier to procure (available from more vendors), and significantly less expensive than an MSR. A network provider may therefore deploy a multitude of tunnel aggregators at different network nodes, spread across disparate locations served by the provider's network, in order to distribute return traffic routed through encapsulation tunnels. In addition, the use of tunnel aggregators allows a network provider to quickly and cost-effectively scale network capacity by having deployable servers in time of demand.

In some examples, a provider may deploy a tunnel aggregator device in physical or logical proximity to an MSR, which may facilitate the routing of return traffic from the MSR to the tunnel aggregator device, for ultimate transmission to a customer endpoint. In other examples, a tunnel aggregator device may be deployed in proximity to other provider network resources, such as a provider edge router. This type of arrangement may require return traffic to be routed from an MSR, through a provider network (such as by clean return virtual routing and forwarding), to the provider edge router, then to the tunnel aggregator device, which ultimately delivers the traffic to the customer via an encapsulation tunnel. Additional details are now provided by way of discussion of the drawings.

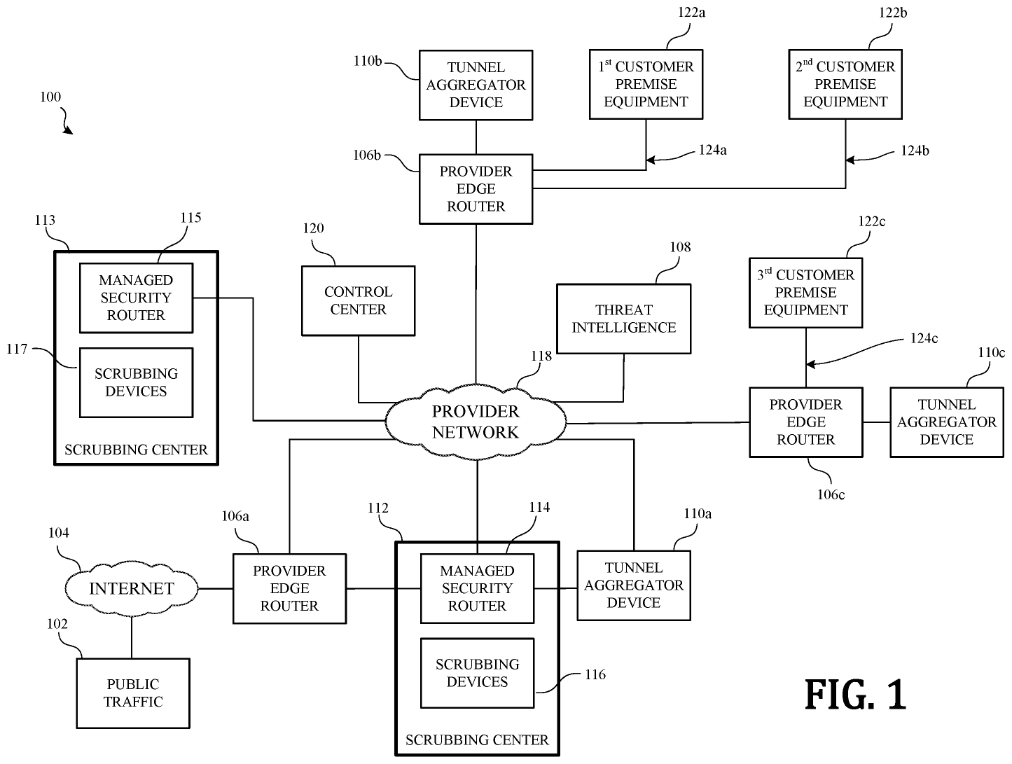

FIG. 1 is a block diagram of an example distributed encapsulation tunnel networking environment 100. The networking environment 100 may include any type of telecommunications network that utilizes IP addresses for connecting one or more components of the network.

In one example, the networking environment 100 includes a provider network 118, which may include provider edge (PE) routers 106a, 106b, and 106c (collectively referred to herein as 106), for transceiving traffic into and out of the provider network 118. The provider network 118 may further include other computing devices or resources of the networking environment 100, such as managed security routers 114 and 115 associated with scrubbing centers 112 and 113 (respectively), a control center 120, and/or other computing devices or resources. The provider network 118 may include additional routers, computing devices, network infrastructure, and/or other equipment that supports IP-based data communication amongst the computing devices/resources coupled to the provider network 118. In some examples, the provider network 118 may be part of the Internet backbone.

In one example, PE router 106a may receive public traffic 102 over the public Internet 104, determine the traffic's destination IP address, determine a route for the traffic (such as through provider network 118), and forward the traffic to another PE router (e.g., router 106b), for delivery to a first customer premise equipment (CPE) 122a.

PE routers 106 may advertise through a border gateway protocol (BGP), or some other routing protocol announcement or advertisement, routes serviced by the router. In examples, BGP is primarily used as the routing protocol since often the encapsulation tunnels will terminate on customer premises that are outside of the network provider's network. For example, the PE routers 106 may provide a BGP advertisement that indicates that CPE 122a, 122b, and 122c (collectively referred to herein as 122) may be accessed through the PE routers 106. In response to the advertisement, public traffic 102 directed to the CPEs 122 may be routed to the CPEs 122 by the PE routers 106, through the provider network 118.

In some examples, the CPEs 122 may be located in proximity to one another or may be co-located, while in other examples the CPEs 122 may be geographically distributed. For instance, the first CPE 122a and second CPE 122b may be located in such proximity to PE router 106b that both CPE 122a and 122b receive traffic through PE router 106b. The third CPE 122c may be located in a different geographic region and may therefore receive traffic through PE router 106c.

In some examples, the CPEs 122 may represent one or more routers or other computing devices owned and/or operated by a single customer, at the edge of the customer's internal network. In other examples, the CPEs 122 may each represent access points for the networks of multiple customers, rather than a single customer. For instance, CPE 122a may be associated with a first customer, CPE 122b may be associated with a second customer, and CPE 122c may be associated with a third customer.

In examples, the CPEs 122 may access provider services, and/or may access computing resources available on the Internet or other networks connected to provider network 118 via Internet circuits 124a, 124b, and 124c (collectively referred to herein as 124). In some instances, the Internet circuits 124 may include the network and computing resources of the provider, while in other instances the Internet circuits may include the network and computing resources of a third-party ISP. In examples, the Internet circuits 124 may be Internet circuits to which the customer is subscribed for the provision of networking services to the customer.

In examples, the computing devices of a customer's network may be configured to provide a computing service (not depicted) to the public and/or to members of the customer's organization. Examples of the computing services provided by the customer's network may include a web page, application programming interface (API), or another computing application configured to process requests and provide content in response to requests. For example, a server on the customer's network may provide content such as text, documents/files, images, audio, video, web pages, IP addresses, domain information, and/or other types of content. The public traffic 102 may include a request directed to the customer's computing service, accessible through one or more CPEs 122. In some examples, a hacker may send malicious requests to the customer's computing service in an attempt to overload the service and prevent legitimate requests from being fulfilled. The malicious requests may take the form of a DDoS attack that floods the customer's service with these superfluous requests.

In an effort to counter DDoS attacks, an administrator of the targeted customer's network may purchase threat mitigation services from the provider to clean/scrub network packets that are identified as a threat and that are directed to the targeted customer's network. As part of the mitigation, incoming public traffic 102 (or other traffic) bound for the customer's network may be re-routed, for example, to a provider's scrubbing center 112 by a PE router, such as PE router 106a, and/or by other routers of the provider network 118. In some examples, the scrubbing center 112 may include an MSR 114, which manages traffic into and out of the scrubbing center 112. In other examples, MSR 114 may not be located directly in the scrubbing center 112 but may still direct traffic into and out of the scrubbing center 112. Similarly, in some examples, traffic may be re-routed to a different scrubbing center 113 with an associated MSR 115.

The MSR 114 (or MSR 115 as applicable) may be configured to route incoming traffic to one or more associated scrubbing devices, such as scrubbing devices 116 (or 117 for scrubbing center 113), where data packets within the traffic are examined to determine which packets are clean/legitimate and which are suspect/malicious. For ease of description, filtering/scrubbing operations are generally described herein in relation to scrubbing center 112; however, similar operations can occur in scrubbing center 113. The malicious packets may be dropped by the scrubbing devices 116 to prevent them from overwhelming the customer's network. The clean/filtered packets are then routed from the scrubbing devices 116 back to the MSR 114 where they may be forwarded to the customer network (e.g., via a CPE 122). The scrubbing centers 112 and 113 may include additional computing devices not depicted in FIG. 1, such as a scrubbing device controller or manager, and/or other elements.

In some examples, the customer may prefer to receive clean return traffic in unencapsulated form. In such instances, the MSR 114 may return the clean traffic to the customer network via provider network 118, the applicable PE router 106 and CPEs 122, without generating an encapsulation tunnel. In examples, the provider network 118 may utilize clean return virtual routing and forwarding (VRF) for routing clean traffic to the customer.

In other examples, the customer may prefer to receive clean return traffic via dedicated encapsulation tunnel established between a source endpoint of the provider and a destination endpoint of the customer. The encapsulation tunnel may be, for example, a GRE tunnel created to encapsulate traffic carried from the provider network 118 across the applicable Internet circuit 124 to the CPE 122. The destination endpoint of the GRE tunnel may be one of the CPEs 122, which may, upon receiving encapsulated traffic, un-encapsulate the received data packets and forward the packets to the appropriate computing device within the customer network. As described, the MSR 114 may serve as an encapsulation tunnel source endpoint, but the capacity of the MSR 114 to perform tunnel encapsulation may be limited.

To address the capacity limitations that may be associated with the use of an MSR as an encapsulation tunnel endpoint, in examples, the provider may deploy one or more tunnel aggregator devices, such as tunnel aggregator devices 110a, 110b, and/or 110c (collectively referred to herein as 110) within provider network 118. A tunnel aggregator device 110 may be a server or other computing device/resource capable of performing the encapsulation tunneling functions typically associated with a router. In examples, a tunnel aggregator device 110 may be a server executing software that allows the server to operate as an open source or virtual router.

In nonexclusive examples, the process of establishing the encapsulation tunnel between a source endpoint in the provider network (such as a tunnel aggregator device 110) and a destination endpoint (such as a CPE 122) in the customer network may include configuring each endpoint to recognize the IP address of the other endpoint. In some examples, establishing the encapsulation tunnel may include configuring the maximum transfer unit (MTU), the data segmentation size, and/or other parameters of the tunnel. In other examples, the tunnel may be configured for keep-alive polling, where the status of the tunnel is verified on a periodic basis. In still other examples, establishing the encapsulation tunnel may involve configuring the tunnel endpoints to perform data packet encryption/decryption, such as when the encapsulation tunnel is an IPsec tunnel.

In examples, establishment of the encapsulation tunnel may be performed automatically by one or more computing devices of the provider network 118, in response to a request for threat mitigation services from a customer. In examples, customer-provided instructions, which may accompany the threat mitigation service request, may be used to configure the tunnel. For example, a specific tunnel aggregator device, such as one of tunnel aggregator devices 110, may be automatically selected as an encapsulation tunnel source endpoint, based on the customer-provided instructions. In examples where the customer-provided instructions do not indicate a selection/preference for a tunnel source endpoint, the threat mitigation system may automatically determine a tunnel aggregator device 110 to serve as an encapsulation endpoint, based on a variety of factors. Those factors may include tunnel aggregator device capacity, location, volume of traffic, availability of other network resources, other network performance considerations, the preference of the service provider, and/or other policies of the provider.

Once an encapsulation tunnel is established between a tunnel aggregator device 110 to corresponding customer destination endpoint, the tunnel aggregator device 110 may be each configured to advertise the customer endpoints serviced by the tunnel aggregator device 110. The tunnel aggregator device 110 may then receive clean traffic to return to a customer endpoint via encapsulation tunneling. For instance, tunnel aggregator device 110a may be configured to establish an encapsulation tunnel with a CPEs 122 and advertise one or more IP addresses indicating that traffic may be routed to the CPE 122 through tunnel aggregator device 110a. In response to the advertisement, and/or based on its own configuration, MSR 114 may route clean return traffic to tunnel aggregator device 110a, which may then provide (i.e., send or transmit) the clean packets to the appropriate CPE 122 by encapsulation tunneling. The tunnel aggregator device 110a and MSR 114 may be configured by the provider to support this type of tunneling arrangement in response to a customer request for threat mitigation services, such as by customer-provided packet routing instructions. For example, a tunnel aggregator device 110 may be selected to receive data packets from MSR 114 based on a combination of customer-provided instructions, provider routing or other preferences, provider policies, tunnel aggregator device 110 capacity, MSR 114 capacity, network routing capacity, and/or other factors.

In some examples, to facilitate packet routing from the MSR 114 to the tunnel aggregator device 110a, the tunnel aggregator device 110a may be co-located with, or in physical proximity to MSR 114, or may otherwise be logically near MSR 114. Upon receiving clean traffic from the MSR 114, the tunnel aggregator device 110a may then encapsulate data packets associated with the clean traffic and provide the encapsulated packets to one of the CPEs 122 through the provider network 118, PE routers 106, and Internet circuits 124.

In other examples, the tunnel aggregator device 110a may receive clean traffic from MSR 115 associated with the second scrubbing center 113 that is not co-located or physically near tunnel aggregator device 110a. MSR 115 may provide clean traffic to tunnel aggregator device 110a based on a combination of customer-provided instructions, provider routing or other preferences, provider policies, tunnel aggregator device 110 capacity, MSR 115 capacity, network routing capacity, and/or other factors. For example, MSR 115 may route clean traffic to tunnel aggregator device 110a based on advertisement/announcement of the IP address of a customer endpoint by the tunnel aggregator device 110a.

In still other examples, the tunnel aggregator device 110a may receive clean traffic from both MSRs 114 and 115, and from other MSRs (not depicted) that may be connected to provider network 118. In examples, the tunnel aggregator device 110a may route clean return traffic received from a plurality of computing devices/resources of provider network 118 to one or more customer endpoints via an encapsulation tunnel.

In some examples, the provider may pair a tunnel aggregator device (e.g., 110b/110c) with a respective PE router 106b/106c, which are in proximity to the CPEs 122. For instance, as depicted in FIG. 1, tunnel aggregator device 110b may be co-located or otherwise in proximity to, or logically near, PE router 106b. The tunnel aggregator device 110b may be configured to advertise IP addresses corresponding to CPEs 122a and 122b, with which the tunnel aggregator device 110b may be configured to establish an encapsulation tunnel. The MSR 114 may be configured to route clean return traffic to PE router 106b through provider network 118. Based on the advertisement by the tunnel aggregator device 110b, and/or on its own configuration, the PE router 106b may then route the clean traffic received from the MSR 114 to the tunnel aggregator device 110b. The tunnel aggregator device 110b (the tunnel source endpoint) encapsulates the data packets associated with the clean traffic and provides the encapsulated packets to either CPE 122a (the tunnel destination endpoint) through PE router 106b and Internet circuit 124a or CPE 122b through PE router 106b and Internet circuit 124b. The CPE router 122a (or CPE router 122b, as applicable) may then provide the unencapsulated data packets to a computing resource within the customer network. In some examples, tunnel aggregator device 110b may return clean traffic via encapsulation tunneling to CPE 122a and/or 122b, and as described above, the MSR 114, PE router 106b, and tunnel aggregator device 110b may be thusly configured during the provisioning of threat mitigation services requested by a customer. In other examples, a tunnel aggregator device 110 may be selected to receive data packets from the MSR 114, through a PE router 106, based on a combination of customer-provided instructions, provider routing or other preferences, provider policies, MSR 114 capacity, PE router 106 capacity, tunnel aggregator device 110 capacity, provider network 118 routing capacity, and/or other factors.

In some examples, a tunnel aggregator device 110 may be selected to receive data packets from MSR 114, MSR 115, both MSR 114 and 115, and/or additional MSRs connected to provider network 118, through a PE router 106. As described above, this selection may be based on a combination of customer or provider preferences, provider policies, computing/network performance, and/or other considerations.

In further examples, the provider may deploy tunnel aggregator devices with a number of PE routers distributed across the provider network 118, beyond what is depicted in FIG. 1. This configuration, where encapsulation tunnel source endpoints are spread throughout the provider's network, may reduce encapsulation tunneling bottlenecks at MSR 114/115, and may allow clean traffic to be more efficiently routed/distributed across computing resources of the provider network 118 in unencapsulated form. That is, encapsulation tunnels may be shorter because the traffic is being encapsulated at a tunnel aggregator device 110 closer to the CPE 122 (the customer tunnel destination endpoint). In examples, this may be helpful in ensuring that the additional packet bloat from the encapsulation is carried by as few network elements as possible.

In some examples, the tunnel aggregator devices 110a, 110b, and/or 110c may each comprise a plurality of processors or devices. For example, tunnel aggregator devices 110 may each be a single server, a cluster of servers, computing device, collection of computing devices, and/or some other computing resource. The distributed arrangement of tunnel aggregator devices 110 allows a provider to scale the encapsulation tunneling capabilities of the provider's threat mitigation service to meet the needs of a particular customer, set of customers, or geographic region served by the provider. For instance, additional tunnel aggregator devices may be added to a site with a specific PE router 106 or geographically localized set of PE routers 106 that service high-traffic regions where a large number of encapsulation tunnels terminate. In this regard, encapsulation tunneling capabilities and resources may be more efficiently deployed/distributed to meet customer demand for clean return traffic via encapsulation tunneling.

In examples, tunnel aggregator devices may be deployed to a plurality of MSRs and PE routers distributed across a provider's network. In one example, the threat mitigation system may be configured such that a plurality of encapsulation tunnels are used to return clean traffic to a single customer endpoint. Clean data packets from scrubbing devices 116 may first be routed to MSR 114, which in turn may route a portion of the return traffic to a second MSR (e.g., MSR 115). In examples, if appropriately configured, either MSR 114 or MSR 115 may route the return traffic to one or more tunnel aggregators 110, which provide the clean traffic to a common customer endpoint (such as one of the CPEs 122).

In some examples, an administrator of a customer network may request and configure threat mitigation services by accessing a control center 120, which may be made available by the provider. Although the control system is depicted in FIG. 1 as a separate system, in examples the control center 120 may be integrated into a scrubbing center, distributed across computing resources comprising, or connected to, the provider network 118, or otherwise made available within the networking environment 100. In some examples, the administrator may access the control center 120 of the provider network 118 using a computing device, such as a desktop or laptop computer, smart phone, customer server, or other type of computing device. The control center 120 may provide a user interface (UI) with which the administrator may interact to configure the threat mitigation service. In other examples, the administrator may configure the threat mitigation service using a method other than a UI, such as an API or another type of interface or method. In still other examples, a network service provider may configure threat mitigation services without involvement from an administrator of a customer network.

As briefly described above, the configuration of threat mitigation services by the administrator/customer may include instructions to the provider that specify the parameters of the provided service and may include selectable service options or preferences. For example, as part of a selectable service option, a customer may enable a DDoS threat intelligence service 108 that automatically determines (or recommends for customer confirmation) whether traffic should be redirected to the scrubbing center 112 and/or 113. This determination or recommendation may be at least partially based on traffic information collected by the DDoS threat intelligence service 108, a threat profile provided by the customer, other screening criteria provided by the customer, and/or screening criteria determined by the provider.

In examples, the DDoS threat intelligence service 108 may be implemented on a server, server cluster, computing device, collection of computing devices, and/or some other computing resource. In some examples, the DDoS threat intelligence service 108 may be operatively connected to the PE routers and one or more other routing or computing elements of provider network 118, including PE router 106a. In still other examples, the DDoS threat intelligence service 108 may distributed across computing devices/resources of provider network 118.

When the DDoS threat intelligence service 108 determines that the traffic directed to the customer network meets one or more threat criteria, the DDoS threat intelligence service 108 may notify computing resources of the networking environment that traffic directed to the customer network should be redirected to the scrubbing center 112, such as to an MSR 114 associated with the scrubbing center 112. In other examples, threat mitigation services always activated (so traffic directed to the customer network is redirected to the scrubbing center 112, such as to an MSR 114 associated with the scrubbing center 112, without involvement of any DDoS threat intelligence service 108. The process outlined above may then be used to return clean traffic to the customer network, e.g., using an encapsulation tunnel. In some examples, traffic directed to the customer network may be redirected to MSR 115 associated with scrubbing center 113, while in other examples some traffic may be redirected to both MSR 114 and/or MSR 115 for further routing to associated scrubbing devices 116 and/or 117. In still other examples, traffic may be directed to a plurality of MSRs and associated scrubbing centers distributed across provider network 118.

In some examples, the customer-provided instructions may include selection of a particular scrubbing center (such as scrubbing center 112 or 113) from among a plurality of scrubbing centers available across the geographic regions serviced by provider network 118. For instance, a customer may configure the threat mitigation service to redirect suspected malicious traffic to a scrubbing center that is nearest in distance to the customer network being serviced, that is logically near the customer network, and/or that minimizes latency of clean return traffic provided to the customer network from the scrubbing center. In other examples, the customer may select a scrubbing center with more capacity to handle clean return traffic or that offers better/higher computing performance relative to other available scrubbing centers. In still other examples, the customer-provided instruction may indicate no selection of a particular scrubbing center, leaving the selection of a scrubbing center to the threat mitigation system.

The customer-provided instructions may further include routing instructions for the return of clean data packets and/or bandwidth or data rate of the return traffic. In examples, the routing instructions may include an indication of whether clean return traffic should be returned via encapsulation tunneling (such as through one or more GRE tunnels), and the maximum allowable bandwidth of the clean return traffic. In examples where encapsulation tunneling is selected, the routing instructions may include selection of an encapsulation tunnel source endpoint, such as a source endpoint that is nearest in distance to the customer network being serviced, or selection of source endpoint that minimizes latency of clean return traffic. In other examples, the routing instructions may include selection of an encapsulation tunnel source endpoint located in a specific geographic region. In still other examples, the customer may specify in the routing instructions the number of encapsulation tunnels to use, the location of the tunnel source endpoints, and/or other routing preferences for the return traffic. In further examples, the routing instructions may indicate that clean traffic should be returned through a combination of encapsulation tunnels and unencapsulated routing. The routing instructions may further include preferences for alternate return paths for clean traffic, in the event of a network equipment outage.

In examples, a customer may request threat mitigation services without including instructions or service preferences. In such examples, computing devices or resources of the provider may configure the routing of suspect/malicious data packets and clean/filtered data packets to different elements within, or coupled to, the provider network 118. Selection of scrubbing centers (such as scrubbing centers 112 and/or 113), MSRs (such as MSR 114 and/or 115), tunnel aggregator devices (such as tunnel aggregator device 110), PE routers (such as PE routers 106), and/or other resources/elements of the provider may be determined by combination of provider preferences or policies, performance capacity, resource availability, routing efficiency, and/or other considerations. These considerations may be made actively by a network provider administrator, or may be determined automatically by computing devices/resources of the provider network 118.

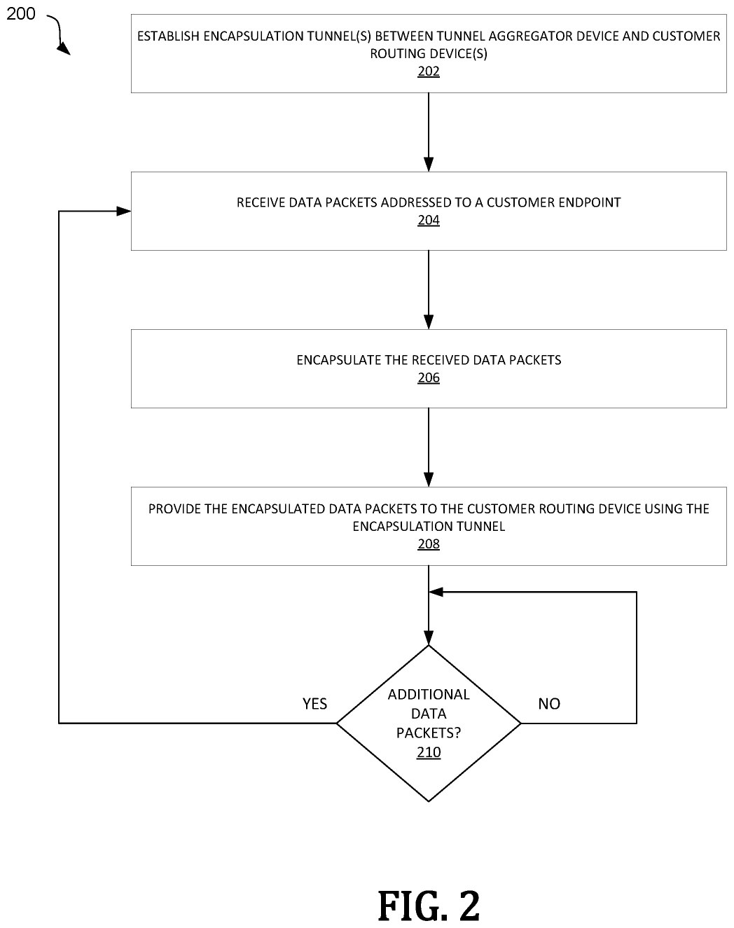

FIG. 2 depicts an example method 200 in which aspects of the present technology may be practiced by a tunnel aggregator device, such as tunnel aggregator devices 110. At operation 202, an encapsulation tunnel, such as a GRE tunnel, may be established between the tunnel aggregator device (tunnel source endpoint) and a CPE (tunnel destination endpoint), such as one of the CPEs 122. In some examples, encapsulation tunnels may be established between the tunnel aggregator device and a plurality of CPEs. The encapsulation tunnels may be established serially (i.e., one encapsulation tunnel established at a time), or may be established in groups or sets of encapsulation tunnels. In examples, encapsulation tunnels may be established on an as-needed and/or on-demand basis. Furthermore, the tunnel aggregator device may be reconfigured, as needed, to establish the encapsulation tunnels with additional CPEs or other endpoints.

As discussed, in examples, establishing the encapsulation tunnel may include configuring each endpoint to recognize the IP address of the other endpoint. In some examples, establishing the encapsulation tunnel may include configuring the maximum transfer unit (MTU), the data segmentation size, and/or other parameters of the tunnel. In other examples, the tunnel may be configured for keep-alive polling, where the status of the tunnel is verified on a periodic basis. In still other examples, establishing the encapsulation tunnel may involve configuring the tunnel endpoints to perform data packet encryption/decryption, such as when the encapsulation tunnel is an IPsec tunnel.

In examples, establishment of the encapsulation tunnel may be performed automatically by one or more computing devices of the provider network, in response to a request for threat mitigation services from a customer. In examples, customer-provided instructions, which may accompany the threat mitigation service request, may be used to configure the tunnel. For example, a specific tunnel aggregator device may be automatically selected as an encapsulation tunnel source endpoint, based on the customer-provided instructions. In examples where the customer-provided instructions do not indicate a selection/preference for a tunnel source endpoint, the threat mitigation system may automatically determine a tunnel aggregator device to serve as an encapsulation endpoint, based on a variety of factors. As described above, those factors may include tunnel aggregator device capacity, location, volume of traffic, availability of other network resources, other network performance considerations, and/or the preference of the service provider.

At operation 204, the tunnel aggregator device receives clean data packets addressed to a customer endpoint. The packets may be provided by an MSR, such as MSR 114, configured to route clean data packets to the tunnel aggregator device, based on customer-provided instructions or the other factors described above. In some examples, the MSR may be one with which the tunnel aggregator device has been co-located, or one that is in physical or logical proximity to the tunnel aggregator device. In other examples, the MSR may be one to which the tunnel aggregator device has advertised/announced the IP address of the customer endpoint receiving the clean data packets. In still other examples, the tunnel aggregator device may be selected to receive data packets based on a combination of customer-provided instructions, provider routing or other preferences, provider policies, tunnel aggregator device capacity, MSR capacity, network routing capacity, and/or other factors. In further examples, the received data packets may be clean/filtered data packets from a scrubbing center associated with the MSR.

In examples, the tunnel aggregator device may receive clean data packets from a PE router, such as from one of the PE routers 106, to which the tunnel aggregator device has advertised/announced the IP address of the customer endpoint receiving the clean data packets. In some examples, the PE router may be one with which the tunnel aggregator device has been co-located, or one that is in physical and/or logical proximity to the tunnel aggregator device. In further examples, the PE router may be operatively connected to a CPE that is the destination endpoint of the encapsulation tunnel, e.g., via Internet circuit 124. The clean data packets may be routed to the PE router from an MSR through the provider's network, such as provider network 118. The data packets routed to the tunnel aggregator through the PE router may be clean/filtered packets from a scrubbing center associated with the MSR.

The customer endpoint to which the received data packets are addressed may be different from the encapsulation tunnel destination endpoint. That is, the encapsulation tunnel destination endpoint may be a customer routing device, such as a CPE, whereas the customer endpoint may be a computing device on the customer's network, such as a server, server cluster, computing device, collection of computing devices, and/or other computing resource. In some examples, the customer endpoint may be a computing device that provides a service to other users of the customer's network, such as employees of the customer/organization, Internet users, or other users. In examples, the customer routing device may be a CPE which routes traffic to the customer endpoint.

At operation 206, the tunnel aggregator device encapsulates the received data packets per the protocols of the established tunnel. As described above, data packet encapsulation involves wrapping a first data packet that uses one protocol inside an outer data packet (encapsulating packet) that uses a different protocol, with a packet header attached to the outer encapsulating packet. The header information of the outer encapsulating packet may specify the endpoints of the tunnel as the source and destination IP addresses. The encapsulated data packet is sent from the source network endpoint (such as a PE router) to a specific target destination endpoint (such as a customer premise router), and any intervening network resources (such as other routers which are not the target destination endpoint) do not access the encapsulated packet, only the header of the outer packet. When the encapsulated data is received at the destination endpoint, the outer data packet and header are removed, and the original (first) data packet can then be accessed.

At operation 208, the tunnel aggregator device provides the encapsulated data packets to the customer routing device via the encapsulation tunnel. In some examples, providing the data packets may include sending or transmitting the data packets point-to-point, in a synchronous manner. For example, the encapsulated data packets may be provided to the customer routing device in defined segments or frames, at a fixed interval or at a certain bandwidth, in accordance with a protocol, such as the Internet Protocol. In other examples, the encapsulated data packets may be provided to the customer routing device asynchronously. In some examples, the data packets may be provided to the customer routing device through the encapsulation tunnel implemented across intervening computing devices or resources, such as intervening routers for example, that are communicatively coupled via wired or wireless connection.

At operation 210, the tunnel aggregator device determines whether additional data packets are available to provide to a customer endpoint via the encapsulation tunnel. In examples, the tunnel aggregator device may wait for additional packets to arrive and may continue to advertise IP addresses to which the tunnel aggregator device is configured to route encapsulated packets. In examples where no additional data packets are received, flow proceeds “no,” and the tunnel aggregator device may continue to await the arrival of additional data packets.

In examples where additional data packets are routed to the tunnel aggregator device, flow proceeds “yes” back to operation 204, and the tunnel aggregator device may perform operations 204-210 for the additional packets. In some examples, the newly received data packets may be addressed to the same customer endpoint as previously received data packets, while in other examples the newly received data packets may be addressed to a different endpoint of the same customer. In still other examples, the newly received data packets may be addressed to one or more endpoints of a different customer.

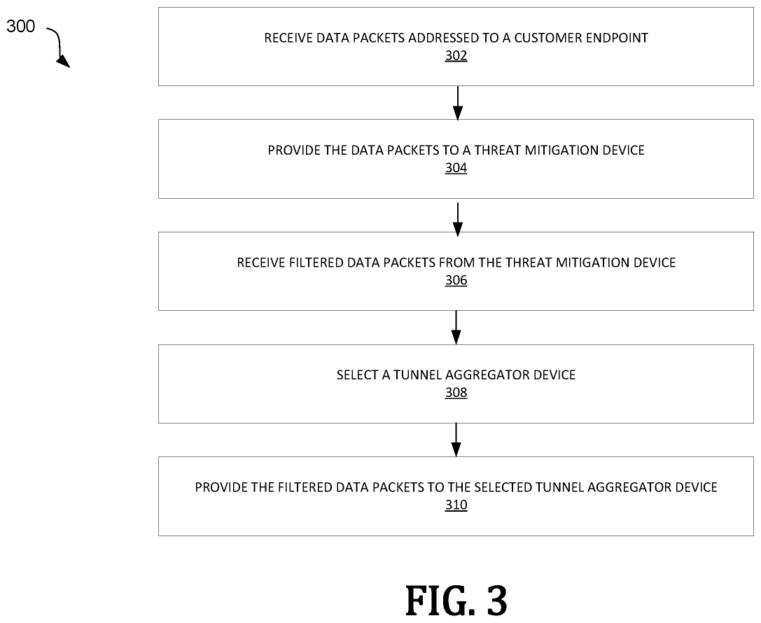

FIG. 3 depicts an example method 300 in which aspects of the present technology may be practiced by one or more managed security routers, such as MSRs 114 and/or 115. At operation 302, a managed security router receives data packets addressed to a customer endpoint. In examples, the data packets may be traffic, such as public traffic 102, directed to a service offered by the customer endpoint, or offered by another computing device on the customer's network. In some examples, the received data packets may originate from the public Internet, such as Internet 104, while in other examples the data packets may originate from another network, such as a private network or a network administered by a third party. In other examples, the received data packets may originate from multiple network sources.

The data packets may be routed to the MSR directly through a PE router, such as a PE router 106. In some examples, the data packets may be routed to the MSR through one or more other elements of the provider's network, such as provider network 118. In examples, the data packets may be routed to the MSR as a result of a request for threat mitigation services by a customer. For instance, in response to the request for threat mitigation services, a threat intelligence system, such as threat intelligence 108, may automatically route traffic to the MSR based on a determination that the traffic may contain malicious data packets. In examples, the threat intelligence system may route traffic to the MSR based on the identification of a suspected DDoS attack.

In examples, the MSR may be part of, or associated with, a scrubbing center, such as scrubbing center 112. The request for threat mitigation services may include customer-provided instructions that specify a particular scrubbing center and/or MSR to use in the provision of threat mitigation services. In other examples, an MSR may be selected to receive data packets based on proximity of the MSR or scrubbing center to the customer's network, CPE, and/or customer endpoint. In still other examples, an MSR may be selected to receive data packets based on a combination of customer-provided instructions, provider routing or other preferences, policies of the provider network, MSR capacity, network routing capacity, and/or other factors.

At operation 304, the MSR provides the data packets to a threat mitigation device, such as one or more scrubbing devices that may be associated with the MSR. The MSR may provide suspect data packets to a threat mitigation device based on the configuration of the MSR. In examples, the configuration may be at least partially based on customer-provided instructions included with the request for threat mitigation services. In some examples, the configuration of the MSR may be based on a combination of customer-provided instructions, provider preferences, and/or other policies of the provider network. In further examples, the MSR may also provide suspect data packets to a threat mitigation device based at least partially on capacity of the MSR, physical or logical proximity of a threat mitigation device to the MSR, data packet latency, number of threat mitigation devices, capacity or availability of a threat mitigation device, and/or other factors. In examples, the MSR may provide the data packets to one or more threat mitigation devices of a plurality of threat mitigations device provided by the threat mitigation system.

At operation 306, the MSR receives filtered data packets from the threat mitigation device. The filtered data packets may include traffic in which data packets identified as, or suspected to be, malicious data packets have been removed from the traffic. The identification and removal of suspect/malicious data packets is performed by the threat mitigation device, which may be (as described above) one or more scrubbing devices of a scrubbing center associated with the MSR. In examples, the identification and removal of suspect/malicious data packets by the threat mitigation device or devices may be part of a mitigation approach to a suspected or actual DDoS attack.

At operation 308, the MSR selects a tunnel aggregator device from a plurality of tunnel aggregator devices available to the MSR. The tunnel aggregator device may be selected based on physical proximity to the MSR, logical proximity to the MSR, and/or other association with the MSR and/or scrubbing center. In examples, the selection of the tunnel aggregator device by the MSR may be based on customer-provided instructions, provider preference, and/or other policy of the provider network. In other examples, selection of the tunnel aggregator device may also be at least partially based on tunnel aggregator capacity, availability of provider network resources (such as intervening routers or other provider equipment), volume of traffic, or other considerations. In still other examples, the MSR may provide the filtered data to a tunnel aggregator device that has advertised/announced the IP address of the customer endpoint receiving the clean data packets.

In some examples, selection of the tunnel aggregator device may be based on proximity of the tunnel aggregator device to the customer network, such as proximity to a CPE serving as the encapsulation tunnel endpoint. Such a tunnel aggregator device may help reduce return traffic latency, may allow a threat mitigation service provider to distribute return traffic more efficiently, and/or may provide other benefits to the provider and/or customer, as previously described. In examples, the tunnel aggregator device may be associated with a PE router that is operatively connected to a CPE of the customer network, e.g., via an Internet circuit. For instance, the tunnel aggregator device may be co-located with a PE router, and/or may be in physical and/or logical proximity to the PE router. The tunnel aggregator device may be one that has advertised/announced the IP address of the customer endpoint receiving the clean data packets.

At operation 310, the MSR provides the filtered or clean data packets to the selected tunnel aggregator device. In examples where the MSR provides the filtered data packets to a tunnel aggregator device associated with a PE router, the MSR may route the filtered packets to the tunnel aggregator device through the PE router. The clean return traffic may be routed to the PE router through the provider's network, such as a portion of the provider's network configured for clean return virtual routing and forwarding.

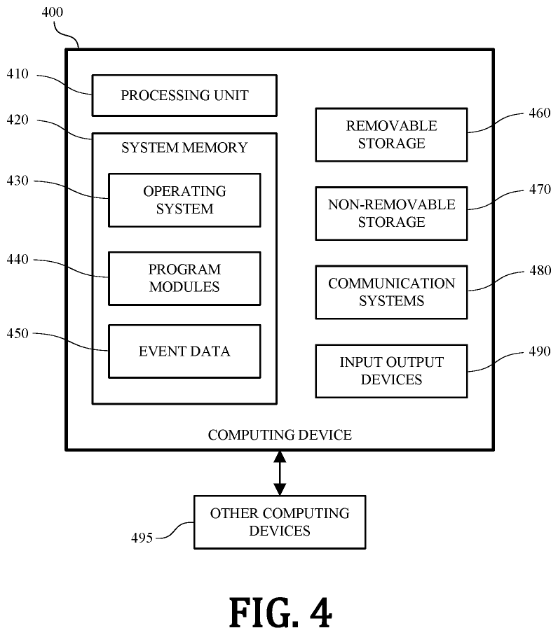

FIG. 4 is a block diagram of an example computing device 400. The computing device 400, or various components and systems of the computing device 400, may be integrated or associated with the provider edge router 106, scrubbing devices 116, DDoS threat intelligence service 108, managed security router 114, tunnel aggregator device 110, control center 120, customer premise equipment 122, and/or other elements of provider network 118. As shown in FIG. 4, the physical components (e.g., hardware) of the computing device are illustrated and these physical components may be used to practice the various aspects of the present disclosure. The elements described above, along with elements of the scrubbing center 112 may be implemented via one or more computing devices 400.

The computing device 400 may include at least one processing unit 410 and a system memory 420. The system memory 420 may include, but is not limited to, volatile storage (e.g., random access memory), non-volatile storage (e.g., read-only memory), flash memory, or any combination of such memories. The system memory 420 may also include an operating system 430 that controls the operation of the computing device 400 and one or more program modules 440. The program modules 440 may be responsible for gathering or determining event data 450 including endpoint data and/or network data. A number of different program modules and data files may be stored in the system memory 420. While executing on the processing unit 410, the program modules 440 may perform the various processes described above.

The computing device 400 may also have additional features or functionality. For example, the computing device 400 may include additional data storage devices (e.g., removable and/or non-removable storage devices) such as, for example, magnetic disks, optical disks, or tape. These additional storage devices are labeled as a removable storage 460 and a non-removable storage 470.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 4 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 400 on the single integrated circuit (chip). The disclosure may also be practiced using other technologies capable of performing logical operations such as, for example, AND, OR, and NOT, including but not limited to mechanical, optical, fluidic, and quantum technologies.

The computing device 400 may include one or more communication systems 480 that enable the computing device 400 to communicate with other computing devices 495 such as, for example, servers, routers, network devices, client computing devices, etc. Examples of communication systems 480 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 400 may also have one or more input devices and/or one or more output devices shown as input/output devices 490. These input/output devices 490 may include a keyboard, a sound or voice input device, haptic devices, a touch, force and/or swipe input device, a display, speakers, etc. The aforementioned devices are examples and others may be used.

The term computer-readable media as used herein may include non-transitory computer storage media. Computer storage media may include volatile and nonvolatile, removable and non-removable media implemented in any method or technology for storage of information, such as computer readable instructions, data structures, or program modules.

The system memory 420, the removable storage 460, and the non-removable storage 470 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media is tangible and non-transitory, and does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The terminology used herein is for the purpose of describing particular embodiments only and is not intended to be limiting of the inventive concept. Also, unless explicitly stated, the embodiments described herein are not mutually exclusive. Aspects of the embodiments described herein may be combined in some implementations.

In regards to the processes in the flow diagrams of FIGS. 2-3, it should be understood that the sequence of steps of the processes are not fixed, but can be modified, changed in order, performed differently, performed sequentially, concurrently, or simultaneously, or altered into any desired sequence, as recognized by a person of skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure.” Also, the term “exemplary” is intended to refer to an example or illustration. As used herein, the terms “use,” “using,” and “used” may be considered synonymous with the terms “utilize,” “utilizing,” and “utilized,” respectively.

Although exemplary embodiments of systems and methods for configuring and using systems and methods have been specifically described and illustrated herein, many modifications and variations will be apparent to those skilled in the art. Accordingly, it is to be understood that the systems and methods for configuring and using systems and methods constructed according to principles of this disclosure may be embodied other than as specifically described herein. The disclosure is also defined in the following claims, and equivalents thereof

What is claimed is:

1. A method comprising:
causing a first encapsulation tunnel to be established between a tunnel aggregator device and a first customer routing device;
receiving, at the tunnel aggregator device and from a first managed security router of a provider network, a first plurality of packets addressed to a first customer endpoint;
encapsulating, by the tunnel aggregator device, the first plurality of packets;
providing the encapsulated first plurality of packets to the first customer routing device using the first encapsulation tunnel;
receiving, at the tunnel aggregator device and from a second managed security router of the provider network, a second plurality of packets addressed to the first customer endpoint;
encapsulating, by the tunnel aggregator device, the second plurality of packets; and
providing the encapsulated second plurality of packets to the first customer routing device using the first encapsulation tunnel.

2. The method of claim 1, wherein the first plurality of packets are received at the tunnel aggregator device over a clean return virtual routing and forwarding system of the provider network in unencapsulated form.

3. The method of claim 1, wherein the tunnel aggregator device is logically closer to the first customer routing device than either of the first managed security router or the second managed security router.

4. The method of claim 1, further comprising:
causing a second encapsulation tunnel to be established between the tunnel aggregator device and a second customer routing device;
receiving, at the tunnel aggregator device and from the first managed security router of the provider network, a third plurality of packets addressed to a second customer endpoint;
encapsulating, by the tunnel aggregator device, the third plurality of packets; and
providing the encapsulated third plurality of packets to the second customer routing device using the second encapsulation tunnel.

5. The method of claim 1, wherein the first plurality of packets and the second plurality of packets are received at the tunnel aggregator device through a premise edge router co-located with the tunnel aggregator device.

6. The method of claim 1, wherein the tunnel aggregator device uses Generic Routing Encapsulation (GRE) to provide the first plurality of packets and the second plurality of packets to the first customer endpoint.

7. The method of claim 1, wherein the tunnel aggregator device uses Internet Protocol Security (IPsec) to provide the first plurality of packets and the second plurality of packets to the first customer endpoint.

8. A method comprising:
receiving, at a first managed security router of a provider network, a first plurality of packets addressed to a first customer endpoint;
providing the first plurality of packets to one or more threat mitigation devices;
receiving, at the first managed security router and from the one or more threat mitigation devices, a first plurality of filtered packets associated with the first plurality of packets; and
providing, based on a configuration of the first managed security router, the first plurality of filtered packets to a first tunnel aggregator device for transmission to the first customer endpoint.

9. The method of claim 8, further comprising:
receiving, at the first managed security router, customer packet routing instructions, wherein the configuration of the first managed security router is at least partially based on the customer packet routing instructions.

10. The method of claim 9, wherein the customer packet routing instructions includes an indication that the first plurality of filtered packets should be provided to the first customer endpoint via an encapsulation tunnel.

11. The method of claim 9, further comprising selecting the first tunnel aggregator device from a plurality of tunnel aggregator devices, wherein the first tunnel aggregator device is selected by the first managed security router based at least partially on the customer packet routing instructions.

12. The method of claim 9, wherein the first plurality of filtered packets is provided to a provider edge router over a clean return virtual routing and forwarding system of the provider network in unencapsulated form.

13. The method of claim 8, further comprising selecting the first tunnel aggregator device from a plurality of tunnel aggregator devices, wherein the first tunnel aggregator device is selected from a plurality of tunnel aggregator devices based on the first tunnel aggregator device being logically closer to the first customer endpoint.

14. A system, comprising:
at least one processor; and
memory, operatively connected to the at least one processor and storing instructions that, when executed by the at least one processor, cause the system to perform a method comprising:
causing a first encapsulation tunnel to be established between a tunnel aggregator device and a first customer routing device;
receiving, at a tunnel aggregator device and from a first managed security router of a provider network, a first plurality of packets addressed to a first customer endpoint;
encapsulating, by the tunnel aggregator device, the first plurality of packets;
providing the encapsulated first plurality of packets to the first customer routing device;
receiving, at the tunnel aggregator device and from a second managed security router of the provider network, a second plurality of packets addressed to the first customer endpoint;
encapsulating, by the tunnel aggregator device, the second plurality of packets; and
providing the encapsulated second plurality of packets to the first customer routing device using the first encapsulation tunnel.

15. The system of claim 15, wherein the first plurality of packets and the second plurality of packets are received at the tunnel aggregator device over a clean return virtual routing and forwarding system of the provider network in unencapsulated form.

16. The system of claim 15, wherein the tunnel aggregator device is logically closer to the first customer routing device than either of the first managed security router or the second managed security router.

17. The system of claim 15, further comprising:
causing a second encapsulation tunnel to be established between the tunnel aggregator device and a second customer routing device;
receiving, at the tunnel aggregator device and from the first managed security router of the provider network, a third plurality of packets addressed to a second customer endpoint;
encapsulating, by the tunnel aggregator device, the third plurality of packets; and
providing the encapsulated third plurality of packets to the second customer endpoint.

18. The system of claim 15, wherein the first plurality of packets and the second plurality of packets are received at the tunnel aggregator device through a premise router co-located with the tunnel aggregator device.

19. The system of claim 15, wherein the tunnel aggregator device uses Generic Routing Encapsulation (GRE) to provide the first plurality of packets and the second plurality of packets to the first customer endpoint.

20. The system of claim 15, wherein a configuration of the first managed security router is at least partially based on customer packet routing instructions.
